(19) United States
(12) Patent Application Publication
(10) Pub. No.: US 2006/0113687 A1
(43) Pub. Date: Jun. 1, 2006

(54) Remote control HVAC air freshener

(76) Inventor: Mark Castellano, Seminole, FL (US)

Correspondence Address: LARSON AND LARSON, 11199 69TH STREET NORTH, LARGO, FL, 33773, US

(21) Appl. No.: 10/998,475

(22) Filed: Nov. 29, 2004

(51) Int. Cl. B01F 3/04

(52) U.S. Cl. 261/26; 261/119.1; 261/121.1; 261/DIG. 88

(57) ABSTRACT

A remote actuator wirelessly sends a signal to a transceiver module to cause an air pump to bubble air via a first tube through a bottle containing a liquid fragrance. The bubbling action causes fragrance vapors to rise through a second tube connected to a HVAC return so that the fragrance is distributed throughout the HVAC system.

### BACKGROUND OF THE INVENTION

1. Field of the Invention

The present invention relates to a system of injecting air freshener materials into an air conditioning return. More specifically, it refers to a system of bubbling forced air into an enclosure containing a desired liquid scent to pump vapors of the scent into an air conditioner return.

2. Description of the Prior Art

It is well known in the prior art to imbed a scent material in air conditioning filters. See U.S. Pat. Nos. 6,117,218; 5,087,273 and 3,902,877. Other means of injecting a scent into an air conditioning system is shown in U.S. Pat. Nos. 3,930,797; 4,617,157; 5,505,378 and 5,971,367. While these methods of injecting a scent into an air conditioning system achieve the intended purpose, they do not control the time when a scent is employed. The search continues for a simple inexpensive means of injecting a scent into an air conditioning system and a means to control the time when the scent is employed.

### SUMMARY OF THE INVENTION

The present invention provides a solution to the problem of controlling the time when a scent is added to an air conditioning system. The invention provides a housing enclosing a bottle containing a liquid scent, an air blower to pump air via a first tube through the liquid in the bottle, a second tube connecting a top area of the bottle to an air conditioner return, a transceiver module electrically connected to the air blower and a wireless remote actuator for the module. By pressing the “on” button on the remote actuator, air is bubbled through the liquid scent causing vapors of the desired scent to be deposited in an air conditioner return. When there is no need for the scent, the off button is pushed and the air blower is turned off.

### BRIEF DESCRIPTION OF THE DRAWINGS

This invention can be best understood by those having ordinary skill in the art by reference to the following detailed description, when considered in conjunction with the accompanying drawings in which:

FIG. 1 is a schematic of the equipment used in the inventive system;

FIG. 2 is a schematic according to FIG. 1 showing a bottle containing the scent receiving air from an air blower and causing scent vapors to be forced into an air conditioner return.

FIG. 3 is a schematic of the system employed in an automobile air conditioner system.

### DETAILED DESCRIPTION OF THE INVENTION

Throughout the following detailed description, the same reference numerals refer to the same elements in all figures.

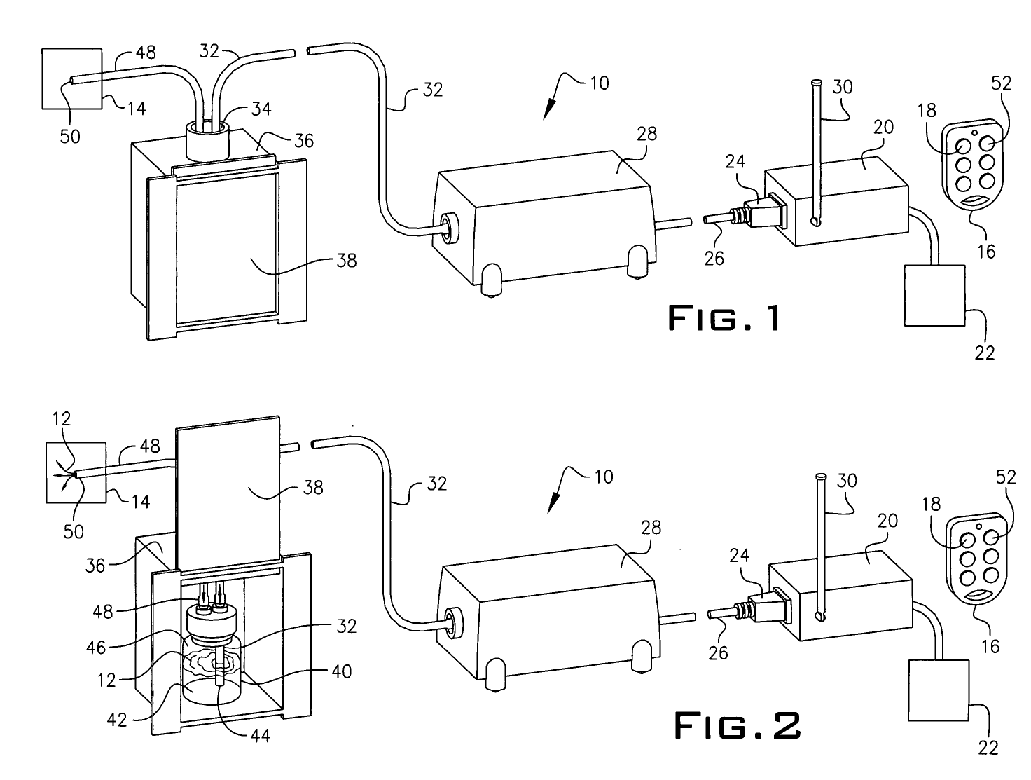

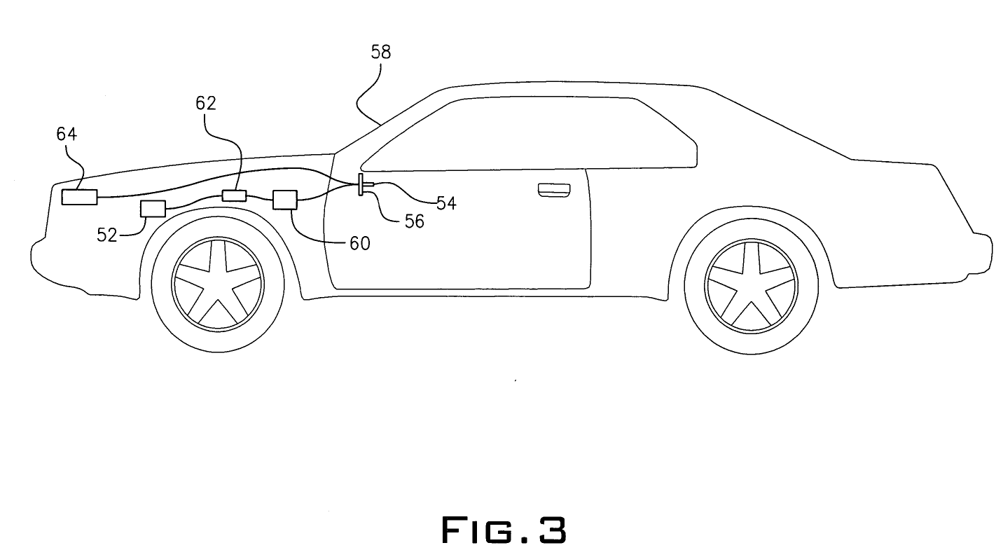

Referring to FIGS. 1 and 2, the system 10 for depositing scent vapors (fragrance) 12 into an HVAC return 14 is actuated by a remote switch 16. An on button 18 sends a signal to a transceiver module 20. The module 20 is plugged into a wall socket 22 carrying a normal house circuit of 120 volts AC. In addition, the module 20 is electrically connected by a plug 24 via electrical cable 26 to an air blower 28. The module 20 has an antenna 30 wirelessly connecting to the remote switch 16. A preferred module 20 is a model TM 751 sold by X-10 (USA), Inc., Closter, N.J. 07624.

The air blower 28 puts out an air output flow minimum of 2500 cc/minute at a pressure to about 4.0 PSI. A preferred commercial air blower is the “Elite” 802. The air from air blower 28 passes through flexible plastic tube 32 and through an opening 34 in housing 36. The housing 36 has a front sliding door 38 which provides access to a bottle 40 containing a liquid scent or fragrance 42. The end 44 of tube 32 is immersed in liquid scent 42 so that air from blower 28 is bubbled through the liquid scent 42 when the “on” switch 18 is depressed. The bubbling action in the liquid scent causes vapors 12 to rise to an upper area 46 of bottle 40 and through exit tube 48 which has an end 50 located in the HVAC return 14. The exit air flow is about 1300 cc/minute at a pressure of 2.0 PSI.

The liquid scent 42 can be any type preferred by the user such as peppermint, clover, vanilla, cinnamon, pine and lemon.

When the desired fragrance is no longer needed such as when no one is present in the household, the off button 52 on switch 16 is pushed to stop the air flow.

Referring to FIG. 3, the system can work equally well in a vehicle air conditioning system 52. A toggle switch 54 on the dashboard 56 of a vehicle 58 actuates a vehicle air pump 60, so that air is directed to a container 62 mounted in the engine compartment. The system is powered by the 12 volt automobile battery 64. In the same manner, as the system shown in FIG. 2, fragrance vapors are inserted into the vehicle air conditioning system.

Equivalent elements can be substituted for elements in the above system to obtain substantially the same results in substantially the same manner.

Having thus described the invention, what is claimed for Letters Patent follows:

1. A system for introducing a fragrance vapor into an air conditioner return duct, the system comprising:
(a) a container partially filled with a liquid having a fragrance;
(b) an air pump having an air flow output passing through a first tube, an end of the first tube distal from the air pump immersed in the liquid having a fragrance, the air pump adapted when electrically activated to cause bubbling in the liquid so that the fragrance vapor rises upwardly in the container;
(c) a transceiver module electrically connected to the air pump and to an electrical power source;
(d) the transceiver module adapted to receive a wireless signal from a remote actuating switch to activate the air pump, and
(e) a second tube leading from a top portion of the container above the liquid to capture the fragrance vapor and transport the fragrance vapor to the air conditioner return duct.

2. The system for introducing a fragrance vapor into an air conditioner return duct according to claim 1 wherein the container is a bottle positioned within a housing, the housing having an opening for receiving the first tube and exiting the second tube.

3. The system for introducing a fragrance vapor into an air conditioner return duct according to claim 1 wherein the air pump produces an air flow rate of at least 2500 cc/minute at a pressure of about 4.0 PSI.

4. The system for introducing a fragrance vapor into an air conditioner return duct according to claim 1 wherein the electrical power source for the transceiver module is a house circuit.

5. The system for introducing a fragrance vapor into an air conditioner return duct according to claim 1 wherein the electrical power source is a 12 volt D.C. battery.

6. A method for introducing a fragrance vapor into an air conditioner return duct, the method comprising:
(a) partially filling a container with a liquid having a fragrance;
(b) providing an air pump having an air flow output;
(c) connecting a first tube to the air flow output and immersing an end of the tube distal from the air pump in the liquid having a fragrance;
(d) electrically connecting a transceiver module to the air pump and connecting the transceiver module to a source of electric power;
(e) providing an antenna connected to the transceiver module for receiving a wireless signal from a remote switch;
(f) inserting a first end of a second tube into the container above the liquid having a fragrance and the second end of the second tube into the air conditioner return duct, and
(g) pressing an “on” button on the remote switch to activate the air blower to cause bubbling in the liquid and generation of a fragrance vapor which rises through the second tube to the air conditioner return.

7. The method according to claim 6 wherein the container is mounted within a housing having an opening for receipt of the first and second tube.

8. The method according to claim 6 wherein the air pump produces an air flow rate at about 2500 cc/minute.

9. The method according to claim 6 wherein the electrical power source for the transceiver module is a house circuit.

10. The method according to claim 6 wherein the electrical power source for the transceiver is a 12 volt D.C. battery.

11. The method according to claim 6 wherein the container is mounted within the air conditioner system of a vehicle.

12. An apparatus for introducing a fragrance vapor into an air conditioner return duct, the apparatus comprising:
(a) a container partially filled with a liquid having a fragrance, the container having a space above the liquid;
(b) an air pump having an air flow output;
(c) a first tube connecting the air pump output to the liquid in the container;
(d) a transceiver module electrically connected to the air pump and to an electrical power source, the transceiver module having an antenna for receiving a wireless signal from a remote switch, and
(e) a second tube connecting the space above the liquid with the air conditioner return duct so that when the remote switch is activated the air pump air flow causes bubbling to occur in the liquid and fragrance vapors rise through the second tube to the air conditioner return duct.

13. The apparatus according to claim 12 wherein the air pump outflow of air is at least 2500 cc/minute.

14. The apparatus according to claim 12 wherein the electrical power source is a house 110 volt AC circuit.

15. The apparatus according to claim 12 wherein the electrical power source is a 12 volt D.C. battery.

16. The apparatus according to claim 12 wherein the container is a bottle mounted within a housing having an opening for passage of the first and second tube.
